(19) United States
(12) Patent Application Publication
(10) Pub. No.: US 2010/0004773 A1
(43) Pub. Date: Jan. 7, 2010

(54) APPARATUS FOR CHARACTERIZATION OF THIN FILM PROPERTIES AND METHOD OF USING THE SAME

(75) Inventor: Vladimir Kochergin, Lewis Center, OH (US)

Correspondence Address: PhysTech, Inc., 5208 Sandy Drive, Lewis Center, OH, 43035, US

(73) Assignee: PHYSTECH, INC, Lewis Center, OH (US)

(21) Appl. No.: 12/488,544

(22) Filed: Jun. 20, 2009

Related U.S. Application Data
(60) Provisional application No. 61/077,482, filed on Jul. 1, 2008.

(51) Int. Cl. G06F 19/00; G01J 3/447

(52) U.S. Cl. 700/103; 356/327

(57) ABSTRACT

This invention provides an apparatus and method for characterization of thin film structures. More particularly, the present invention provides methods and devices for fast and accurate identification of optical constants, thickness, interface roughness and stresses of a sensing film structures by spectropolarimetric imaging technique. This invention also provides the method for active in-line manufacturing diagnostics and process control. The invention is broadly applicable with most important applications being manufacturing diagnostics, process control, quality control and characterization of solar cells, flat panel displays and semiconductor structures.

### CROSS-REFERENCES TO RELATED APPLICATIONS

The present non-provisional application relates to previously filed provisional application No. 61/077,482 with filing date Jul. 1, 2008

### STATEMENT REGARDING FEDERALLY SPONSORED RESEARCH OR DEVELOPMENT

Not applicable.

### FIELD OF THE INVENTION

The present invention relates to an apparatus and method for thin film characterization. In more detail, the present invention is related to the apparatus and method for measuring the spectral dependences of refractive indices, thicknesses, birefringence and/or interface roughness of thin film structures through the use of hyperspectral imaging. The apparatus and method of present invention can be applied for thin film characterization quality control and in-situ process monitoring. In-line manufacturing diagnostics of solar cells is one of the preferred applications of the technology disclosed in present invention.

### BACKGROUND OF THE INVENTION

Photovoltaic (PV) technology is predicted to have a very substantial impact on nation's wealth and economy in 21st century since such an energy-generating technology offers high reliability, little necessary maintenance, reduced environmental impact, it can be produced domestically and many other benefits to the nation's economy, security and ecology. The main obstacle for widespread use of PV energy at present is the higher cost of PV energy compared to that of fossil energy, resulting at large, from the high cost of PV modules.

For example, commercial success of thin film photovoltaics at present is limited by performance and cost, the factors that are typically interrelated and negatively impacted by the lack of reliable and accurate process monitoring and control. The fully integrated process control in PV manufacturing lines will ultimately improve performance, process throughput, and yield of thin film PV modules. To achieve this goal, every manufacturing step must be controlled at a level where quality and yield are maximized. A critical requirement is the development of in-line thin film monitoring and diagnostics tools that can quantitatively assess the thin film properties.

At present, diagnostic capabilities for thin film PV manufacturing are rudimentary, and manufacturers can only assess their product after module completion. In-situ, real-time process diagnostics development, in the form of sensors (or thin film characterization equipment), is required.

For a nonlimiting example, let's consider the CIGS (copper indium gallium diselenide) PV manufacturing. Key processes includes: deposition of molybdenum back contact, deposition of large area CIGS absorber layer, deposition of cadmium sulfide, deposition of transparent conductive oxide (each deposition process typically taking place in dedicated deposition tool); fully automated laser scribing; module lamination, and PV product finishing equipment. To reduce the cost and increase the PV module quality, yield and performance, intelligent outer loop control, based on in-situ film property diagnostics, are needed to be implemented for the Mo, CIGS, CdS and ITO deposition processes. In-situ measurements of film properties would provide information directly and provide the much needed improvement in PV manufacturing process. In-situ, real time measurements of includes minority carrier lifetime, doping density, composition, surface quality, stress, grain size (if any), interface roughness, etc. is needed. Moreover, because solar cells are large area devices, their characteristics strongly depend on local properties; i.e., spatial distribution of parameters listed above is needed to provide an effective in-line diagnostics for PV manufacturing. The sampling process should be very fast to qualify for in-line (or in-situ) diagnostics. This makes the development of PV manufacturing diagnostic systems a serious challenge.

It is impossible to measure all the critical parameters of the solar cell with a apparatus based on a single physical phenomenon. For example, visible imaging has already been used for CdS thickness-to-color correlation and showed sufficient speed and spatial information for in-line PV manufacturing diagnostics [L. J. Simpson, et al., “Process Control Advancements for Flexible CIGS PV Module manufacturing”, NCPV and Solar Program Review Meeting 2003. Unfortunately, such a technique is incapable of providing any relevant information for multilayer structures, such as refractive indices or stresses in individual layers. Other optical techniques, such as spectroscopic ellipsometry, are capable of providing a wealth of information, such as thickness, refractive indices (and through that the composition) of individual layers in solar cells [D. Levi et al., “In-situ Studies of the Growth of Amorphous and Microcrystalline Silicon Using Real-Time Spectroscopic Ellipsometry”, NCPV and Solar Program Review Meeting, 2003, NREL/CD-520-33586, page 778]. However, spectroscopic ellipsometry technique is slow because provides only single-point information, thus incompatible with efficient in-line diagnostics (state of the art systems offer the throughput of ˜1 wafer/minute compared to less than a wafer/second throughput requirement). A number of other methods have been proposed to solve this problem, but none of them is practical enough (fast, accurate and capable of providing sufficient information) to permit effective in-line PV manufacturing diagnostic.

It is an object of the present invention to provide an optical technique that will be capable to provide the wealth of information as spectroscopic ellipsometry on the significant area of the solar cell in a “single shot,” thus providing the opportunity to perform efficient in-line manufacturing diagnostics. Following sections will provide necessary background on the ellipsometry, spectroscopic ellipsometry and hyperspectral imaging required to understand the present invention.

Ellipsometry is widely used for characterization of thin film and multilayer samples [R. M. A. Azzam and N. M. Bashara, Ellipsometry and Polarized Light (North Holland, Amsterdam, 1977)]. Automatic ellipsometric systems capable of real time measurements are also well known in the art over last 30 years or so [Collins, “Automatic Rotating Element Ellipsometers: Calibration, Operation and Real-Time Applications”, Rev. Sci. Instrum., 61(8) (1990)].

Ellipsometry technique (schematically illustrated in FIG. 1) typically involve causing a beam of electromagnetic radiation 1.2 (monochromatic for basic ellipsometry, or polychromatic for spectroscopic ellipsometry), in a known state of polarization 1.3, to interact (typically through reflection process) with a Device Under Test 1.1 (DUT) at least one angle of incidence with respect to a normal to a surface. Changes in the polarization state 1.8 of said beam of electromagnetic radiation which occur as a result of said interaction with the DUT are indicative of the structure and composition of the DUT. To retrieve the useful information on the DUT from ellipsometric measurements a mathematical model of the ellipsometer system and the DUT is typically implemented and a numerical algorithm for fitting the momdel parameters to the experimental data is used.

Typically, in ellipsometric measurements, for each wavelength and/or angle of incidence of said beam of electromagnetic radiation on the DUT, the values of the following parameters are obtained: Ψ, related to a change in a ratio of magnitudes of orthogonal components rₚ/rₛ in said beam of electromagnetic radiation upon reflection from the DUT, and Δ, related to a phase shift entered between said orthogonal components rₚ and rₛ. The basic equation relating Ψ and Δ is: rₚ/rₛ=tan(Ψ)exp(iΔ). By using appropriate models and some apriori information the following information on DUT can be obtained: layer thicknesses, (including thicknesses for multilayers), optical thicknesses, sample temperature, refractive indices and extinction coefficients, index grading, sample composition, surface roughness, alloy and/or void fraction, etc.

Ellipsometer Systems (schematically illustrated in FIG. 2) generally include a source of a beam of electromagnetic radiation 2.3, a Polarizer means 2.4, which serves to impose a linear state of polarization on a beam of electromagnetic radiation, and an Analyzer means 2.8 which serves to select a polarization state in a beam of electromagnetic radiation after it has interacted with a DUT 2.2 (positioned on a sample holder 2.1), and pass it to a Detector System 2.9. Optionally, one or more Compensator(s) can be present and serve to affect a phase angle change between orthogonal components of a polarized beam of electromagnetic radiation (2.5 and 2.7 in FIG. 2).

Basic ellipsometer systems are typically equipped with monochromatic source of electromagnetic radiation (such as laser), while spectroscopic ellipsometer systems utilize a Source which simultaneously provides a plurality of wavelengths, which source can be termed a “broadband” source of electromagnetic radiation.

A variety of ellipsometer systems is known to those skilled in the art, such as those which include rotating elements and those which include modulation elements. Those including rotating elements include Rotating Polarizer (RP), Rotating Analyzer (RA) and Rotating Compensator (RC).

U.S. Pat. No. 4,053,232 to Dill et al. describes a Rotating-Compensator Ellipsometer System, which operates utilizes monochromatic light and is providing ellipsometric measurements at a single spatial point of a sample in a time. Two patents, U.S. Pat. Nos. 5,596,406 and 4,668,086 to Rosencwaig et al. and Redner respectively, describe ellipsometric systems which utilize Polychromatic light and capable of measuring a single spatial point at a time in investigation of material systems. A patent to Johs et al., U.S. Pat. No. 5,872,630 describes a spectroscopic rotating compensator material system investigation system comprising a source of a polychromatic beam of electromagnetic radiation, a polarizer, a stage for supporting a material system, an analyzer, a dispersive optics and at least one detector system which contains a multiplicity of detector elements, said spectroscopic rotating compensator material system investigation system further comprising at least one compensator(s) positioned at a location selected from the group consisting of: before said stage for supporting a material system; after said stage for supporting a material system; and both before and after said stage for supporting a material system; such that when said spectroscopic rotating compensator material system investigation system is used to investigate a material system present on said stage for supporting a material system, said analyzer and polarizer are maintained essentially fixed in position and at least one of said at least one compensator(s) is caused to continuously rotate while a polychromatic beam of electromagnetic radiation produced by said source of a polychromatic beam of electromagnetic radiation is caused to pass through said polarizer and said compensator(s), said polychromatic beam of electromagnetic radiation being also caused to interact with said material system, pass through said analyzer and interact with said dispersive optics such that a multiplicity of essentially single wavelengths are caused to simultaneously enter a corresponding multiplicity of detector elements in said at least one detector system. Still, said U.S. Pat. No. 5,872,630 fails to disclose the system capable of measurements of DUT in more than one point at a time. Patents to Aspnes et al. (U.S. Pat. Nos. 6,320,657 B1, 6,134,012, 5,973,787 and 5,877,859) also describe a Broadband Spectroscopic Rotating Compensator Ellipsometer System and also fail to disclose the system capable of providing measurements over the number of points on the DUT at a time.

A patent to Woollam et al, U.S. Pat. No. 5,373,359 describes a Rotating Analyzer Ellipsometer System which utilizes white light. Patents continued from the 359 Woollam et al. patent are, U.S. Pat. No. 5,504,582 to Johs et al. and U.S. Pat. No. 5,521,706 to Green et al. Said 582 Johs et al. and 706 Green et al. patents describe use of polychromatic light in a Rotating Analyzer Ellipsometer System. As with previously discussed inventions, these disclosures also fail to provide the measurements over the multiple spatial points of the DUT at a time.

Examples of inventions offering the variations of Rotating Polarizer Elliplosmeters include U.S. Pat. Nos. 5,757,494 and 5,956,145 to Green et al., are teaching a method for extending the range of Rotating Analyzer/Polarizer ellipsometer systems (the further prior art is well cited in this disclosure). Said Patents describes the presence of a variable, transmissive, bi-refringent component which is added, and the application thereof during data acquisition to enable the identified capability.

Another prior art that have to be cited in relation to the present invention is the U.S. Pat. No. 7,075,650 “Discrete polarization state spectroscopic ellipsometer system and method of use” Johs; Blaine D. (Lincoln, Nebr.), Liphardt; Martin M. (Lincoln, Nebr.), He; Ping (Lincoln, Nebr.), Hale; Jeffrey S. (Lincoln, Nebr.) Jul. 11, 2006.

A Patent to Coates et al., U.S. Pat. No. 4,826,321 is disclosed as it describes applying a reflected monochromatic beam of plane polarized electromagnetic radiation at a Brewster angle of incidence to a sample substrate to determine the thickness of a thin film thereupon. This Patent also describes calibration utilizing two sample substrates, which have different depths of surface coating.

Other Patents which describe use of reflected electromagnetic radiation to investigate sample systems are U.S. Pat. Nos. RE 34,783, 4,373,817, and 5,045,704 to Coates; and U.S. Pat. No. 5,452,091 to Johnson.

A number of papers is also addressing the in-situ sample characterization with spectroscopic ellipsometry. These include for a nonlimiting example “Atomic Scale Characterization of Semiconductors by In-Situ Real Time Spectroscopic Ellipsometry”, Boher et al., Thin Solid Flims 318 (1998); “Feasibility and Applicability of Integrated Metrology Using Spectroscopic Ellipsometry in a Cluster Tool”, Boher et al., SPIE Vol. 4449, (2001); “Characterization of Wide Bandgap Thin Film Growth Using UV-Extended Real Time Spectroscopic Ellipsometry Applications to Cubic Boron Nitride”, Zapien et al., J. of Wide Bandgap Materials, Vol 9, No. 3 (January 2002); “Automated Rotating Element Ellipsometers: Calibration, Operation, and Real-Time Applications”, Collins, Rev. Sci. Instrum. 61 (8) (August 1990); “Waveform Analysis With Optical Multichannel Detectors: Applications for Rapid-Scan Spectroscopic Ellipsometers”, An et al., Rev. Sci. Instrum. 62(8), (August 1991); and “Multichannel Ellipsometer for Real Time Spectroscopy of Thin Film Deposition for 1.5 to 6.5 eV”, Zapien et al., Rev. Sci. Instrum. Vol. 71, No. 9, (September 1991); “In Situ Multi-Wavelength Ellipsometric Control of Thickness and Composition of Bragg Reflector Structures”, by Herzinger, Johs, Reich, Carpenter & Van Hove, Mat. Res. Soc. Symp. Proc., Vol. 406, (1996).

A book by Azzam and Bashara titled “Ellipsometry and Polarized light” North-Holland, 1977 is disclosed and incorporated herein by reference for general theory.

As mentioned previously in this disclosure, the known to those skilled in the art spectroscopic ellipsometry systems, while providing wealth of information on the multilayer thin film structures (for a nonlimiting example, solar cell structures), are often too slow for the use in effective in-line manufacturing diagnostics. For a nonlimiting illustrative example, according to [J. Kalejs et al., “Advances in High Throughput Wafer and Solar Cell Technology for EFG Ribbon”, in: Proc. 29th IEEE PVSC (2002), p. 74], the solar cell track time in EFG ribbon technology is expected to move into subsecond range, while for all known spectroscopic ellipsometry techniques the mapping of solar cell parameters take more than few seconds (typically in the minute range).

The solution for the aforementioned problem is the spectropol arimetric imaging or spectroscopic ellipsometric imaging in which the spectral ellipsometric or polarimetric information is collected over all the DUT (such as solar cell) surface. Example of such apparatus is the aoutonulling imaging ellipsometer EP3 line from Nanofilm (Germany) with spectroscopic ellipsometry option. Such a system utilize the filter wheel with 46 narrow bandpass filters and provide ellipsometric imaging measurements at the transmission bands of the narrow wbandpass filters sequentially. Such a system still has a number of important drawbacks: 1) the filter wheel assembly makes system mechanically complex and thus expensive, 2) the spectral resolution of the system is limited by the quantity and optical characteristics of filter system, and, most importantly for thin film in-line characterization, 3) the sampling rate of the system is limited by mechanical rotation of the filter wheel and is in a range of few seconds to few tens of the seconds, thus not fast enough for many in-line manufacturing diagnostic applications, such as, for a nonlimiting example, manufacturing of solar cells or flat panel displays.

Based on the review of the prior art it is clear that the new optical apparatus and method are needed for effective in-line manufacturing diagnostics of thin film processes. The present invention addresses this problem by employing the spectropolarimetric imaging technique based on hyperspectral imaging.

Today the hyperspectral imaging is gaining wide acceptance in various applications. In such a technique the spectral characteristics for each point of the image are obtained by recording the image in a large number of spectral bands simultaneously, as illustrated in FIG. 3. Computer Tomographic Hyperspectral Imaging (CTHI) is an attractive type of hyperspectral imaging, which records all the spectral data at the same time. It was recently developed for astronomy and defense applications [M. I Descour and E. Dereniak, “Computed-tomography imaging spectrometer: experimental calibration and reconstruction results”, Applied Optics, Vol. 34, No. 22, (1995), p. 4817-4826], [W. R. Johnson et al., Optics Express, Vol. 12 (No. 10), 2004, pp. 2251-2257], and was suggested for fluorescent imaging [B. K Ford et al., Optics Express Vol. 9, No. 9, pp. 444-453, 2001]. In CTHI (as illustrated in FIG. 4) the three dimensional continuous Field-of-View (FOV) function f(x,y,λ) (which is the spatial-spectral distribution of irradiance) is mapped onto a finite discrete two-dimensional photodetector array (such as CCD camera, CMOS camera or any other camera or focal plane array known to those skilled in the art) with the help of a dispersing element (DE).

The mapping procedure is completely characterized by the impulse-response function H(x,y,λ|r), where r is the coordinate in the plane of two-dimensional photodetector array. If the intensity distribution in the plane of photodetector array is g(r), then the following relation holds:

g(r)=H(x,y,λ|r)*f(x,y,λ)+n(r) (1)

where * denotes the convolution and n(r) is the noise distribution. For computational purposes it is convenient to reformulate (1) with the help of finite discrete H-matrix, representing the operator H(x,y,λ|r) in (1). If we use the subscript n to index pixels gₙ of the measurement g(r) and subscript m to index the conceptual {Δx,Δy,Δλ} sized voxels fₘ of the modeled object, then (1) takes the following form:

\vec{g}=Ĥ\vec{f}+\vec{n} (2)

The H-matrix is determined during calibration, so the problem of tomographic hyperspectral imager is to reconstruct the vector f from measured g and known H. The direct inversion of (2) is often ill-posed, so other methods of hypercube (cubic portion of the spatio-spectral space) reconstruction are used for these purposes.

Multiplicative Algebraic Reconstruction Technique (MART) is shown to be quite useful for such purposes [B. K Ford et al., Optics Express Vol. 9, No. 9, pp. 444-453, 2001]. The iterative reconstruction is done with the following formula:

$${\vec{f}}^{k + 1} = {\vec{f}}^{k} \frac{{\hat{H}}^{T} \vec{g}}{{\hat{H}}^{T} \hat{H} {\vec{f}}^{k}} \qquad ( 3 )$$

where T indicates matrix transpose and Ĥ^{T}\vec{g} and Ĥ^{T}Ĥ\vec{f}^{k} form the back-projection of the collected raw image and the current image estimate, respectively. The multiplication and division are taken to be element-by-element operations [A. Lent, “A convergent algorithm for maximum entropy image restoration”, in Image Analysis and Evaluation, Rodney Shaw, ed. SPSE Proceedings, 249-257 (1976)]. B. K. Ford et al. [Optics Express Vol. 9, No. 9, pp. 444-453, 2001] concluded that 7-8 iterations are optimal, although the number of required iteration can be different for different CTHIS sensors depending on the structure of the DE (i.e., used number of diffraction orders, degree of overlap between these orders, needed accuracy, etc.). The initial estimate of the object cube, \vec{f}⁰, corresponds spatially to the zero-order image and is spectrally uniform. There are other methods of solving the aforementioned inverse problem known for those skilled in the art, such as the Expectation Maximization algorithm [C. E. Volin, “Portable snapshot infrared imaging spectrometer,” PhD thesis, University of Arizona, Tucson, Ariz. 2000]. The heuristic reconstruction method that is claimed to be significantly faster than MART was disclosed by Vose and Horton [M. D. Vose and M. D. Horton, “A heuristic technique for CTIS image reconstruction”].

Besides the snapshot hyperspectral imaging reviewed above significant progress has been made to date on extending computer tomography approach to polarimetric and spectropolarimetric imaging for aerospace, defense and NDE (nondestructive evaluation) applications. Direct extension of the CTHI technique to spectropolarimetric imaging was disclosed in a number of publications from U. of Arizona team. The papers that have to be cited are: [E. L. Dereniak, “Infrared Spectro-Polarimeter”, Proc. of SPIE Vol. 5957 59570X (2005)]; [N. A. Hagen, E. L. Dereniak, and D. T. Sass, “Visible snapshot imaging spectro-polarimeter,” Proc. of SPIE Vol. 5888, 588810 (2005)]. The schematic drawing illustrating the optical setup is provided in FIG. 5. The data acquired by a spectro-polarimeter can be interpreted as an image of a four-dimensional volume, since a measure of radiance is obtained for four independent variables or indices: two spatial variables (x, y), wave number or wavelength (σ or 1/λ), and the Stokes vector index (j=0,1,2,3). In order to understand the principles of operation of U. Arizona system one have to review the operation of channeled spectropolarimeter, known to those skilled in the art and disclosed in a number of papers, for example, [K. Oka and T. Kato, “Spectroscopic polarimetry with channeled spectrum”Opt. Lett. 24, 1475 (1999)].

In a channeled spectro-polarimeter, the incident radiation (which can be described a four-element Stokes vector spectrum S(σ)) passes through two thick (high order) retarders and a polarizer, and the irradiance spectrum of the exiting light is recorded by a spectrometer. The fast axis of the first retarder is aligned with the transmission axis of the polarizer, and the second retarder is oriented with its fast axis at, for a nonlimiting example, 45° to the polarizer's axis. The recorded spectrum is a linear superposition of the Stokes component spectra of the incident light, in which the coefficients are sinusoidal terms depending on the retardances of the retarders. Since each retardance is nominally proportional to wave number σ, the Stokes component spectra are modulated. With proper choice of modulation frequencies (defined by retarder thicknesses and materials) the Stokes component spectra can be separated in the Fourier domain. The modification of channeled spectropolarimetric (non-imaging) approach has been shown to provide complete Mueller matrix characterization, as disclosed by M. Dubreuil et al. [“Snapshot Mueller matrix polarimeter by wavelength polarization coding,” Optics Express, Vol 15, No 21, 13660 (2007)].

By integration of channeled spectropolarimetry technique with a CTHI system, one can realize a snapshot imaging spectro-polarimeter. The introduction of the retarders in the collimated space before the disperser occurs at locations where these components are needed optically to modulate the spectrum, as illustrated in FIG. 5. It should be noted that such a technique has not been yet proposed and/or applied to thin film characterization applications. It is also should be noted that as disclosed in the referenced previously papers, this technique may not be extended to such applications because of the following deficiencies/omitted subjects: 1) to realize thin film characterization and in-line manufacturing control system one needs to add illumination system with proper spectral and polarization properties; 2) the calibration technique, employed in U. Arizona experiments (mechanical scanning of the fiber coupled to a monochromator in the object plane) is very time consuming and hardly practical in the field, 3) hypercube reconstruction algorithm is very time consuming and is not fast enough to such applications as solar cell or flat panel display manufacturing in-line diagnostics. The present invention will effectively address all these deficiencies.

Besides the spectro-polarimetric imaging background, for the purpose of better understanding of the present invention it is worthwhile to review few prior art polarimetric imaging schemes that provide polarimetric imaging at a single wavelength or a narrow wavelength range. Particularly, a snapshot imaging polarimeter based on Savart plates, disclosed by K. Oka and N. Saito [“Snapshot complete imaging polarimeter using Savart plates,” Proc. of SPIE Vol. 6295, 629508, (2006)] has to be reviewed. The optical scheme of such a imaging polarimeter is schematically illustrated in FIG. 6. Such a scheme a series of polarization optics, consisting of a Savart plate #1, a half wave plate, a Savart plate #2, and an analyzer, is placed between the collimator system and reimaging optics. Each Savart plate is made of two uniaxial crystals. In one of the uniaxial crystals, the incident light is split into the ordinary (o) and extraordinary (e) beams and the lateral displacement is introduced only for the extraordinary beam. The Savart plate splits the orthogonally-polarized components of the incident beam into the parallel beams which are laterally separated with each other along the 45° direction with respective to its polarization axes.

In such a realization of imaging polarimeter, the orthogonal polarization-axes of both Savart plates are aligned to ±45° directions with respective to the selected direction denoted as x-axis (a selected orientation in the plane perpendicular to the direction of the incident beam propagation). Each Savart plate thereby introduces the lateral shear in parallel to the y-axis (the direction in the plane of the incident beam propagation, perpendicular to the x-axis). The half wave plate rotates the polarization-coordinate by 45° and the analyzer extracts the linearly-polarized component along the x-axis. With this configuration, the light launched into Savart plate #1 is split into four waves and recombined over the Focal Plane Array (FPA). Since any combinations of the four waves interfere with each other, multiple interference fringes are generated over the FPA.

Let S₀(x, y), S₁(x, y), S₂(x, y), and S₃(x, y) be the two-dimensional distributions of the Stokes parameters of the light emerging from the sample. The image recorded by FPA will be:

I(x, y)=½ S₀(x, y)+½ S₂(x, y) cos [2πU₂y]−¼ |S₁₃(x, y)|cos{2π(U₂−U₁)y−arg [S₁₃(x, y)]}+¼ |S₁₃(x, y)|cos {2π(U₂+U₁)y+arg [S₁₃(x, y)]} (4)

with S₁₃(σ)=S₁(σ)+iS₃(σ) (5)

where arg denotes the operator to take the argument of the complex number, and U₁ and U₂ are the spatial carrier frequencies introduced by the respective Savart plates. The obtained image will consist of one slowly-varying and three quasi-cosinusoidal components, and each component carries the information of S₀(x, y), S₂(x, y), or S₁₃(x, y). The respective components can be extracted from the image by using the spatial frequency filtering, because they have different spatial carrier frequencies f_{y}=0, U₂, U₂−U₁, and U₂+U₁. The two-dimensional distributions of the Stokes parameters can be determined from the amplitudes and the phases of the extracted components. It should be noted that due to small spatial shifts of the different polarization components this technique is well suited for incoherent light as well. The deficiency of such a technique for thin film characterization is the absence of the spectral data which would provide very poor estimation of the thin film sample structure, thus making it not well suited for the thin film characterization and processing control applications.

### SUMMARY OF THE INVENTION

It is an object of the present invention to provide a practical method and apparatus for high-speed characterization of thin film structures for such applications as, for a nonlimiting example, in-line manufacturing diagnostics of solar cell and flat panel display production lines. More particularly, it is an object of the present invention to provide an imaging ellipsometric and or polarimetric system with no mechanical scanning or rotation, or electro-optical tuning by employing hyper-spectral polarimetric imaging technique. It is another object of the present invention to provide a method of using the thin film characterization system of the present invention. The methods and apparatus of the present invention may be used to characterize the thickness, dispersion of refractive index and absorption coefficient of individual layers in multilayer thin film structure (and through that to provide the estimate on composition of said layer), interface roughness and stress distribution on at least one region over the sample surface at a single “shot” (i.e., from the single captured image). The very fast data acquisition speed of the system of present invention makes it particularly well suited for applications requiring high speed characterization, such as in-line manufacturing process control applications. Further, the present invention provides a thin film characterization system that is capable of detecting temporal and spatial variations of the device under test, such as solar cell structure during the processing, providing the opportunity for active adjustment of the processing conditions (closed-loop control). In addition to in-line manufacturing diagnostic and quality control the system and method of the present invention can be used in such nonlimiting applications as characterization of the biological and chemical samples, semiconductor processing, interference filter fabrication to name a few.

In one embodiment of the present invention the thin film characterization system comprises:
a) a broadband light source,
b) an optical assembly for delivery of light emitted by said light source to the first polarization assembly,
c) a first polarization assembly for defining the state of polarization of the light emitted by said light source,
d) a device under test illuminated by light emitted by said light source with polarization state defined b y the first polarization assembly which modifies the spectral and polarization content of the reflected light in response to the structure of said device under test,
e) an optical assembly for delivery of light reflected from device under test to the second polarization assembly,
f) a second polarization assembly for modulating the spectral content of light reflected from device under test according to the polarization state of said reflected light,
g) a hyperspectral imaging optical assembly comprised of at least one dispersive optical component and a photodetector means, and
h) a data processing means for reconstructing spatio-spectro-polarimetric distribution of reflectivity from the device under test and identification of the structural parameters of the device under test on at least one spatial location on the surface of the device under test.

The broadband light source according to the first embodiment of the present invention emits light with continuous emission spectrum over at least some spectral band wide enough to provide meaningful information on the structure of at least one layer in Device Under Test.

The optical assembly (hereafter denoted as OA1) for delivery of light emitted by the light source to the first polarization assembly (hereafter denoted as PA1), is used to produce a collimated or quasi-collimated beam of polychromatic light toward the PA1.

The first polarization assembly (PA1) is used to select a predetermined polarization state of the light illuminating the Device Under Test.

The Device Under Test according to one aspect of the present embodiment comprises at least one layer of material on the substrate of different material. The surface of the film according to the one aspect of the present invention may be optically flat. Alternatively, the surface of the film may be structured or roughened. According to this aspect of the present invention the Device Under Test is illuminated by said polychromatic light at an angle that the polarization state of the reflected light is modified substantially because of the structural properties of the Device Under Test (such as thicknesses and optical constants of the individual thin film layers comprising device under test, surface and interface roughness or structure, stresses in the DUT, etc). The light reflected by the DUT will thus contain a spectro-polarimetric feature related to the DUT's thin film structure.

According to this embodiment of the present invention an optical assembly (hereafter denoted as OA2) for delivery of light reflected from the DUT to the second polarization assembly (hereafter denoted as PA2) may comprise at least one optical lens for beam shaping and beam focusing.

According to the present embodiment a second polarization assembly for modulating the spectral content of light reflected from device under test according to the polarization state of said reflected light may comprise two retarder plates and a polarizer. The fast axis of the first retarder is aligned with the transmission axis of the polarizer, and the second retarder is oriented with its fast axis at a predetermined angle with respect to the polarizer's axis. The transmitted through the PA2 light will thus have spectrum at each portion of the beam containing a linear superposition of the Stokes component spectra of the light reflected from the DUT, in which the coefficients are sinusoidal terms depending on the retardances of the retarders. The Stokes component spectra in each portion of the light beam transmitted through the PA2 will be thus modulated providing the means to be later separated in the Fourier domain.

According to this embodiment of the present invention the hyperspectral imaging assembly comprises at least one dispersive optical component and photodetector means. Said dispersive optical component serves to provide a dispersed image on the plane of photodetector means. Said dispersive optical component can be one or two dimensional reflection or transmission type diffraction grating providing nondispersed (zero diffraction order) and at least one dispersed (higher diffraction orders) images of the DUT to the photodetector means. Said photodetector means comprises a set of photodetectors arranged in two dimensions such as CCD camera, CMOS camera or any other camera known to those skilled in the art. Optical imaging assembly can comprise one or more lenses, aperture (or field stop) and any other optical elements known to those skilled in the art for image formation, shaping and delivery. According to one aspect of the present invention the hyperspectral imaging optical assembly further contains the gray scale mask for uniformization of the intensity distribution in the plane of the photodetector means. The purpose of the hyperspectral imaging optical assembly is to provide the necessary data for reconstruction of spatio-specto-polarimetric reflectivity from the DUT.

According to the first embodiment of the present invention the data processing means comprises reconstructing spatio-spectro-polarimetric distribution of the reflectivity from the DUT. The reconstruction of the spatio-spectro-polarimetric distribution of the reflectivity can comprise the steps of computer tomographic hyperspectral reconstruction and polarimetric reconstruction. The computer tomographic hyperspectral reconstruction can be performed by using MART, Expectation Maximization algorithm, heuristic algorithm or any other algorithm known to those skilled in the art. Polarimetric reconstruction can be performed by steps of inverse Fourier transform, filtering the transformed data array and Fourier transform of the filtered data in the spectral domain. Further mathematical processing may be performed as well (such as normalization by the reference spectrum, smoothing, fitting, etc). The reconstructed data will thus provide the means for further processing to identify the structural parameters of the DUT.

In second embodiment of the present invention the thin film characterization system comprises:
a) a broadband light source,
b) an optical assembly for delivery of light emitted by said light source to the first polarization assembly,
c) a first polarization assembly for defining the state of polarization of the light emitted by said light source,
d) a device under test illuminated by light emitted by said light source with polarization state defined b y the first polarization assembly which modifies the spectral and polarization content of the reflected light in response to the structure of said device under test,
e) an optical assembly for delivery of light reflected from device under test to the second polarization assembly,
f) a second polarization assembly for modulating the spatial content of light reflected from device under test according to the polarization state of said reflected light,
g) a hyperspectral imaging optical assembly comprised of at least one dispersive optical component and a photodetector means, and
h) a data processing means for reconstructing spatio-spectro-polarimetric distribution of reflectivity from the device under test and identification of the structural parameters of the device under test on at least one spatial location on the surface of the device under test.

The broadband light source according to the second embodiment of the present invention emits light with continuous emission spectrum over at least some spectral band wide enough to provide meaningful information on the structure of at least one layer in Device Under Test. It can be an incandesced light bulb, a white light Light Emitting Diode (LED), or any other light source meeting the continuous broadband emission requirement known to those skilled in the art.

The optical assembly (hereafter denoted as OA1) for delivery of light emitted by the light source to the first polarization assembly (hereafter denoted as PA1) may comprise at least one optical lens. The OA1 is used to produce a collimated or quasi-collimated beam of polychromatic light toward the PA1.

The first polarization assembly (PA1) may comprise the polarizing component, such as Glan-Thompson polarizer, wire-grid polarizer or any other polarizing component known to those skilled in the art to select a predetermined linear polarization state of the transmitted light. According to another aspect of the present embodiment the PA1 may comprise a combination of the polarizer and a wave plate, such as quarter wave plate, half wave plate or any other polarization component known to those skilled in the art. According to the present embodiment the PA1 is defining the state of polarization of light illuminating the device under test. The polarization state of the transmitted light may be set to be linearly polarized. Alternatively, it may be set to be circularly or elliptically polarized. The polarization state of the transmitted light might be polarized differently at different portions of its spectrum.

The Device Under Test according to one aspect of the present embodiment comprises at least one layer of material on the substrate of different material. The surface of the film according to the one aspect of the present invention may be optically flat. Alternatively, the surface of the film may be structured or roughened. According to this aspect of the present invention the Device Under Test is illuminated by said polychromatic light at an angle that the polarization state of the reflected light is modified substantially because of the structural properties of the Device Under Test (such as thicknesses and optical constants of the individual thin film layers comprising device under test, surface and interface roughness or structure, stresses in the DUT, etc). The light reflected by the DUT will thus contain a spectro-polarimetric feature related to the DUT's thin film structure.

According to this embodiment of the present invention an optical assembly (hereafter denoted as OA2) for delivery of light reflected from the DUT to the second polarization assembly (hereafter denoted as PA2) may comprise at least one optical lens for beam shaping and beam focusing.

According to the second embodiment of the present invention a second polarization assembly (PA2) for modulating the spatial content of light reflected from device under test according to the polarization state of said reflected light may comprise at least one Savart plate and a polarizer. According to another aspect of the present embodiment the PA2 may comprise two Savart plates, half wave plate and a polarizer. Each Savart plate is made of two uniaxial crystals. In one of the uniaxial crystals, the light reflected from the DUT is split into the ordinary (o) and extraordinary (e) beams and the lateral displacement is introduced only for the extraordinary beam. The Savart plate splits the orthogonally-polarized components of the light reflected from the DUT into the parallel beams which are laterally separated with each other along the 45° direction with respective to its polarization axes. The orthogonal polarization-axes of both Savart plates are aligned to predetermined directions. Each Savart plate thereby introduces the lateral shear. The half wave plate rotates the polarization-coordinate by 45° and the analyzer extracts the linearly-polarized component along the certain polarization axis. With this configuration, the light reflected from the DUT is split into four waves in PA2 thus providing the spatial encoding of the polarization state of the light.

According to this embodiment of the present invention the hyperspectral imaging assembly comprises at least one dispersive optical component and photodetector means. Said dispersive optical component serves to provide a dispersed image on the plane of photodetector means. Said dispersive optical component can be one or two dimensional reflection or transmission type diffraction grating providing nondispersed (zero diffraction order) and at least one dispersed (higher diffraction orders) images of the DUT to the photodetector means. Said photodetector means comprises a set of photodetectors arranged in two dimensions such as CCD camera, CMOS camera or any other camera known to those skilled in the art. Optical imaging assembly can comprise one or more lenses, aperture (or field stop) and any other optical elements known to those skilled in the art for image formation, shaping and delivery. According to one aspect of the present invention the hyperspectral imaging optical assembly further contains the gray scale mask for uniformization of the intensity distribution in the plane of the photodetector means. The purpose of the hyperspectral imaging optical assembly is to provide the necessary data for reconstruction of spatio-specto-polarimetric reflectivity from the DUT.

According to the second embodiment of the present invention the data processing means comprises reconstructing spatio-spectro-polarimetric distribution of the reflectivity from the DUT. The reconstruction of the spatio-spectro-polarimetric distribution of the reflectivity can comprise the steps of computer tomographic hyperspectral reconstruction and polarimetric reconstruction. The computer tomographic hyperspectral reconstruction can be performed by using MART, Expectation Maximization algorithm, heuristic algorithm or any other algorithm known to those skilled in the art. Polarimetric reconstruction can be performed by steps of inverse Fourier transform, filtering the transformed data array and Fourier transform of the filtered data in the spatial domain. Further mathematical processing may be performed as well (such as normalization by the reference spectrum, smoothing, fitting, etc). The reconstructed data will thus provide the means for further processing to identify the structural parameters of the DUT.

According to the third embodiment, the present invention provides a method of thin film characterization with the spectropolarimetric imaging apparatus of the present invention. Said method comprises: (i) calibration of the spectropolarimetric imaging apparatus, (ii) irradiation of the surface of the device under test (comprising at least one thin film) with polychromatic light with predetermined polarization state so that the light is internally or externally reflected at said surface of the device under test, said light possessing a spectropolarimetric features upon reflection from the thin film layer structure of the device under test, (iii) modulating spatially or spectrally the reflected light according to the polarization state of said reflected light, (iv) dispersing the reflected modulated light by a dispersive element, (v) imaging the dispersed light on a two-dimensional photodetector, (vi) measuring the intensities of dispersed and undispersed light reflected from different parts of the device under test and impinging on different parts of the photodetector, (vii) data processing to retrieve spectropolarimetric reflectivity distribution over the surface of the device under test, (viii) providing an optical model of the thin film layers of the device under test, (ix) providing guess values of the parameters of the thin film layers of the device under test, (x) performing fitting procedure to find the values of the thin film structure of the device under test in at least one spatial point of the image of surface of the device under test.

According to the fourth embodiment, the present invention provides a method of diagnostics and control of thin film fabrication processes with the spectropolarimetric imaging apparatus of the present invention. Said method comprises: (i) calibration of the spectropolarimetric imaging apparatus, (ii) generating preliminary data illustrative of the expected and desired specropolarimetric spatial characteristics of the thin film structure, (iii) measurements of the thin film structure with spectropolarimetric imaging apparatus of the present invention, (iv) mathematically comparing said preliminary generated data with measured data and identifying the degree and spatial locations over thin film structure where the difference between the expected data and measured data exceeds the preliminary set fabrication tolerances, (v) partially reconstructing the spatio-spectro-polarimetric hypercube in the said locations where the difference between the expected data and measured data exceeds the preliminary set fabrication tolerances, (vi) mathematically processing the reconstructed data and identifying the guess on fabrication parameters to be adjusted, (vii) adjusting the fabrication parameters to minimize the difference between expected and measured data.

The method and apparatus of the present invention are broadly applicable for characterization, quality control and manufacturing diagnostics of the thin film structures. The present method is particularly useful for in-line manufacturing diagnostics and control of solar cell, flat panel displays and semiconductor devices, where high speed characterization tool is required to meet the manufacturing process throughput. The advantage of the method and apparatus of the present invention is that they provide high-throughput, high accuracy/high resolution technique for thin film characterization.

### BRIEF DESCRIPTION OF THE DRAWINGS

These and other features and advantages of presently preferred non-limiting illustrative exemplary embodiments will be better and more completely understood by referring to the following detailed description in connection with the drawings, of which:

FIG. 1 is a schematic exemplary illustrative drawing illustrating the principles of ellipsometry;

FIG. 2 is a schematic drawing illustrating the prior art ellipsometer system;

FIG. 3 is a schematic drawing illustrating the principle of hyperspectral imaging;

FIG. 4 is a schematic drawing illustrating the principle of computer tomographic hyperspectral imaging;

FIG. 5 is a schematic drawing illustrating the prior art channeled spectropolarimetric imaging system employing pair of retarders;

FIG. 6 is a schematic illustrative exemplary drawing showing the prior art snapshot imaging polarimeter employing pair of Savart plates;

FIG. 7 is a schematic illustrative exemplary drawing showing the thin film characterization system according to the first embodiment of the present invention;

FIG. 8 is a schematic illustrative exemplary drawing showing the thin film characterization system according to the second embodiment of the present invention;

FIG. 9 is a schematic illustrative exemplary drawing showing the calibration article of the present invention.

FIG. 10 is a schematic illustrative exemplary drawing showing the calculated distribution of intensity in the plane of photodetector array in computer tomographic hyperspectral imaging instrument;

FIG. 11 is a schematic drawing illustrating the method of thin film characterization according to the first method of the present invention.

FIG. 12 is a schematic illustrative exemplary drawing showing the calculated intensity distribution in the plane of FPA in tomographic hyperspectral imager with highlighted data portions that are needed for reconstruction of the data cube portion around the detected anomaly

FIG. 13 is schematic exemplary drawing illustrating the method of the thing film characterization and in-line diagnostics according second method present invention.

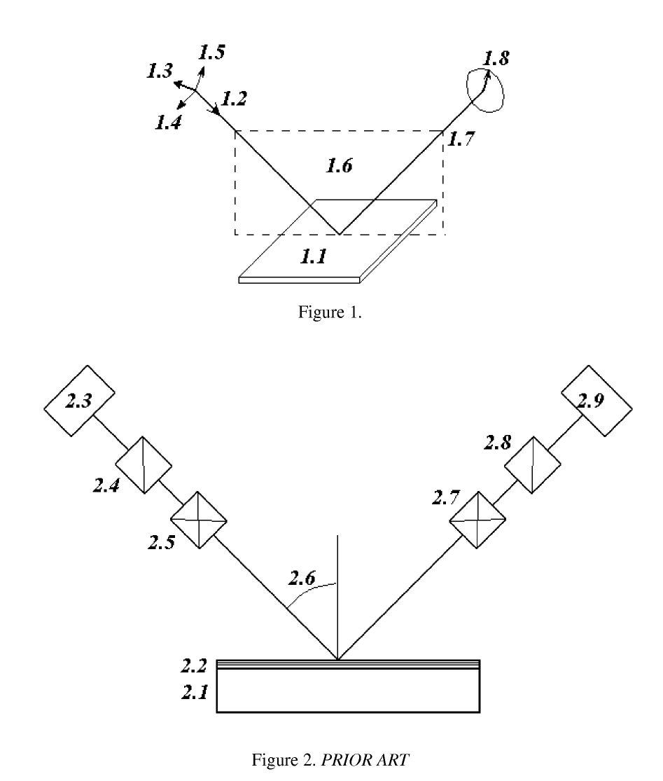

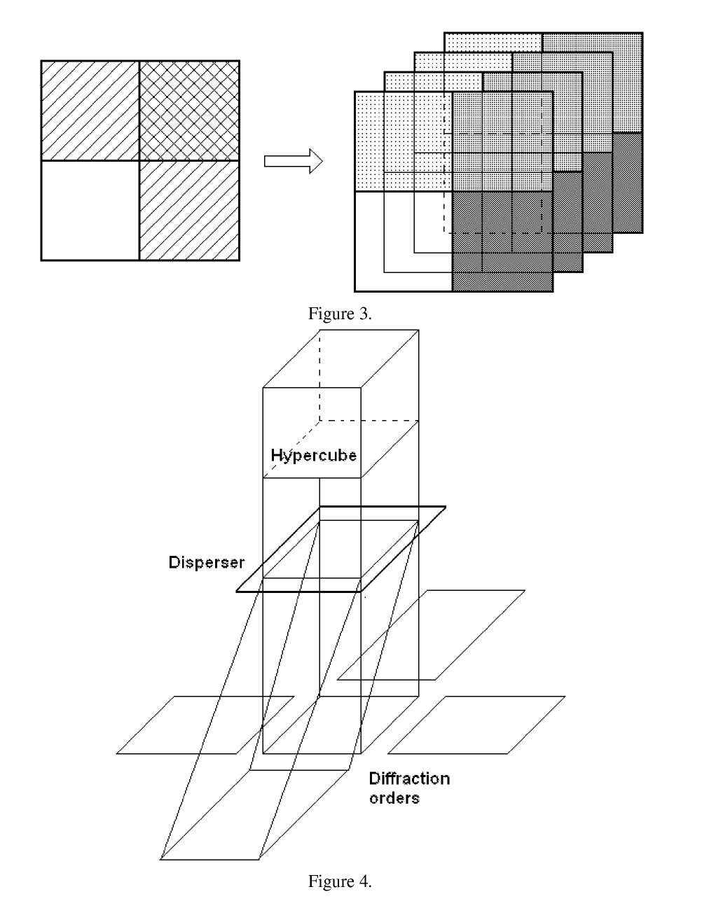

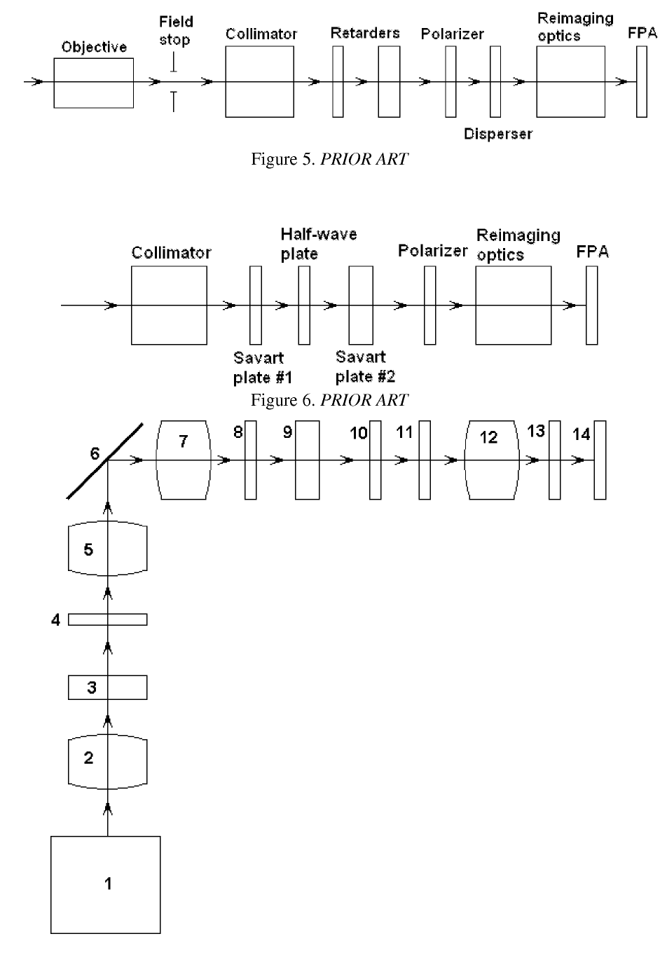

### DETAILED DESCRIPTION OF THE INVENTION

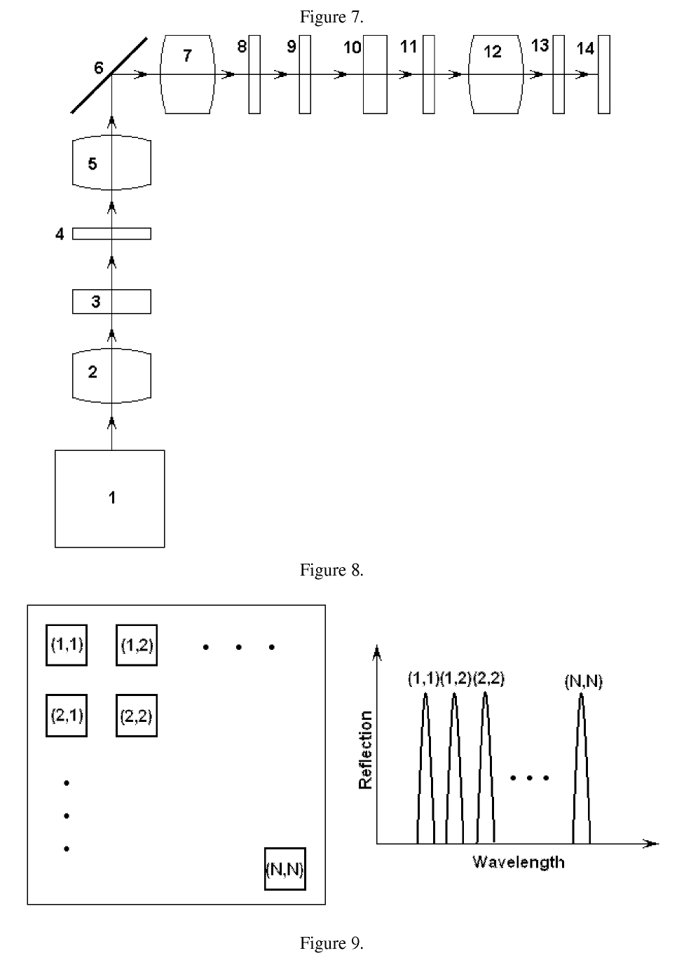

The thin film characterization apparatus according to the first embodiment of the present invention is illustrated by an exemplarily nonlimiting FIG. 7. It comprises:
a) a broadband light source (component 1 in FIG. 7),
b) an optical assembly (component 2 in FIG. 7) for delivery of light emitted by said light source to the first polarization assembly,
c) a first polarization assembly (components 3,4 in FIG. 7) for defining the state of polarization of the light emitted by said light source,
d) a device under test (component 6 in FIG. 7) illuminated by light emitted by said light source with polarization state defined b y the first polarization assembly which modifies the spectral and polarization content of the reflected light in response to the structure of said device under test,
e) an optical assembly (component 7 in FIG. 7) for delivery of light reflected from device under test to the second polarization assembly,
f) a second polarization assembly (components 8, 9, 10 in FIG. 7) for modulating the spectral content of light reflected from device under test according to the polarization state of said reflected light,
g) a hyperspectral imaging optical assembly (components 11, 12, 13, 14 in FIG. 7) comprised of at least one dispersive optical component (component 11 in FIG. 7) and a photodetector means (component 14 in FIG. 7), and
h) a data processing means for reconstructing spatio-spectro-polarimetric distribution of reflectivity from the device under test and identification of the structural parameters of the device under test on at least one spatial location on the surface of the device under test.

The broadband light source (component 1 in FIG. 7) according to the first embodiment of the present invention emits light with continuous emission spectrum over at least some spectral band wide enough to provide meaningful information on the structure of at least one layer in Device Under Test. It can be an incandesced light bulb, a white light Light Emitting Diode (LED), or any other light source meeting the continuous broadband emission requirement known to those skilled in the art. For infrared applications it may comprise a black body source.

The optical assembly (hereafter denoted as OA1) for delivery of light emitted by the light source to the first polarization assembly (hereafter denoted as PA1) may comprise at least one optical lens (component 2 in FIG. 7). The OA1 is used to produce a collimated or quasi-collimated beam of polychromatic light toward the PA1. While it is preferable that the components comprising OA1 are made of either achromatic optical parts or dispersion compensated by design, this requirement is not essential for the functioning of the apparatus of the present embodiment and some applications may be well addressed without meeting the achromatic and/or dispersion compensation requirement.

The first polarization assembly (PA1, components 3 and 4 in FIG. 7) may comprise the polarizing component, such as Glan-Thompson polarizer, wire-grid polarizer or any other polarizing component known to those skilled in the art to select a predetermined linear polarization state of the transmitted light. According to another aspect of the present embodiment the PA1 may comprise a combination of the polarizer and a wave plate, such as quarter wave plate, half wave plate or any other polarization component known to those skilled in the art. It is preferred to use achromatic or dispersion compensated components, although non achromatic components can be used as well and the dispersion effects can be at least partially compensated by the proper calibration and mathematical post-processing of the data. According to the present embodiment the PA1 is defining the state of polarization of light illuminating the device under test. The polarization state of the transmitted light may be set to be linearly polarized. Alternatively, it may be set to be circularly or elliptically polarized. The polarization state of the transmitted light might be polarized differently at different portions of its spectrum.

The beam-shaping optical assembly (component 5 in FIG. 7) can be optionally added to the apparatus of the present embodiment. It may comprise, for example, a beam expanding means known to those skilled in the art to accommodate the characterization of large area device under test. Other types of beam shaping components or assemblies can be used as well to accommodate the requirements of the particular application.

The Device Under Test (component 6 in FIG. 7) according to one aspect of the present embodiment comprises at least one layer of material on the substrate of different material. For a nonlimiting example, it can comprise a semiconductor/dielectric stack (such as the solar cell) on polymer metal substrate. For another nonlimiting example, the device under test may comprise a dielectric stack such as the flat panel display structure. The surface of the film according to the one aspect of the present invention may be optically flat. Alternatively, the surface of the film may be structured or roughened. For a nonlimiting example of solar cell, the surface of the device under test may be structured with random or regular structure (such as an antireflection coating) with certain period (for regular structure) or root mean square parameter characterizing the structure (in the case of random structuring). For such applications it may be advisable to use mid wave infrared optics or long wave infrared optics to minimize the diffraction and blurring effects.

According to this aspect of the present invention the Device Under Test is illuminated by said polychromatic light at an angle that the polarization state of the reflected light is modified substantially because of the structural properties of the Device Under Test (such as thicknesses and optical constants of the individual thin film layers comprising device under test, surface and interface roughness or structure, stresses in the DUT, etc). For a nonlimiting example the angle of illumination may be Brewster angle or pseudo-Brewster angle. The light reflected by the DUT will thus contain a spectro-polarimetric feature related to the DUT's thin film structure.

According to the first embodiment of the present invention an optical assembly (hereafter denoted as OA2, component 7 in FIG. 7) for delivery of light reflected from the DUT to the second polarization assembly (hereafter denoted as PA2) may comprise at least one optical lens for beam shaping and collimation. It may comprise, for a nonlimiting example, two lenses and a spatial filter (for example, a pinhole) to change the size of the beam, to better collimate it and to filter it spatially. While it is preferable that the components comprising OA1 are made of either achromatic optical parts or dispersion compensated by design, this requirement is not essential for the functioning of the apparatus of the present embodiment and some applications may be well addressed without meeting the achromatic and/or dispersion compensation requirement.

According to the present embodiment a second polarization assembly for modulating the spectral content of light reflected from device under test according to the polarization state of said reflected light may comprise two retarder plates (components 8 and 9 in FIG. 7) and a polarizer (component 10 in FIG. 7). The fast axis of the first retarder is aligned with the transmission axis of the polarizer, and the second retarder is oriented with its fast axis at a predetermined angle (for a nonlimiting example, 45°) with respect to the polarizer's axis. The transmitted through the PA2 light will thus have spectrum at each portion of the beam containing a linear superposition of the Stokes component spectra of the light reflected from the DUT, in which the coefficients are sinusoidal terms depending on the retardances of the retarders. The Stokes component spectra in each portion of the light beam transmitted through the PA2 will be thus modulated providing the means to be later separated in the Fourier domain.

According to the first embodiment of the present invention the hyperspectral imaging assembly comprises at least one dispersive optical component (component 11 in FIG. 7) and photodetector means (component 14 in FIG. 7). Said dispersive optical component serves to provide a dispersed image on the plane of photodetector means. Said dispersive optical component can be one or two dimensional reflection or transmission type diffraction grating providing nondispersed (zero diffraction order) and at least one dispersed (higher diffraction orders) images of the DUT to the photodetector means. Said photodetector means comprises a set of photodetectors arranged in two dimensions such as CCD camera, CMOS camera or any other camera known to those skilled in the art. Optical imaging assembly (component 12 in FIG. 7) may be optionally used in the apparatus of the present embodiment and can comprise one or more lenses, aperture (or field stop) and any other optical elements known to those skilled in the art for image formation, shaping and delivery. According to one aspect of the present invention the hyperspectral imaging optical assembly further contains the gray scale mask (component 13 in FIG.7) for uniformization of the intensity distribution in the plane of the photodetector means. The purpose of the hyperspectral imaging optical assembly is to provide the necessary data for reconstruction of spatio-specto-polarimetric reflectivity from the DUT.

According to the first embodiment of the present invention the data processing means comprises reconstructing spatio-spectro-polarimetric distribution of the reflectivity from the DUT. The reconstruction of the spatio-spectro-polarimetric distribution of the reflectivity can comprise the steps of computer tomographic hyperspectral reconstruction and polarimetric reconstruction. The computer tomographic hyperspectral reconstruction can be performed by using MART, Expectation Maximization algorithm, heuristic algorithm or any other algorithm known to those skilled in the art. Polarimetric reconstruction can be performed by steps of inverse Fourier transform, filtering the transformed data array and Fourier transform of the filtered data in the spectral domain. Further mathematical processing may be performed as well (such as normalization by the reference spectrum, smoothing, fitting, etc). The reconstructed data will thus provide the means for further processing to identify the structural parameters of the DUT.

The thin film characterization apparatus according to the second embodiment of the present invention is illustrated by an exemplarily nonlimiting FIG. 8. It comprises:
a) a broadband light source (component 1 in FIG. 8),
b) an optical assembly (component 2 in FIG. 8) for delivery of light emitted by said light source to the first polarization assembly,
c) a first polarization assembly (components 3 and 4 in FIG. 8) for defining the state of polarization of the light emitted by said light source,
d) a device under test (component 6 in FIG. 8) illuminated by light emitted by said light source with polarization state defined b y the first polarization assembly which modifies the spectral and polarization content of the reflected light in response to the structure of said device under test,
e) an optical assembly (component 7 in FIG. 8) for delivery of light reflected from device under test to the second polarization assembly,
f) a second polarization assembly (components 8, 9 and 10 in FIG. 8) for modulating the spatial content of light reflected from device under test according to the polarization state of said reflected light,
g) a hyperspectral imaging optical assembly (components 11, 12, 13 and 14 in FIG. 8) comprised of at least one dispersive optical component (component 11 in FIG. 8) and a photodetector means (component 14 in FIG. 8), and
h) a data processing means for reconstructing spatio-spectro-polarimetric distribution of reflectivity from the device under test and identification of the structural parameters of the device under test on at least one spatial location on the surface of the device under test.

The broadband light source (component 1 in FIG. 8) according to the second embodiment of the present invention emits light with continuous emission spectrum over at least some spectral band wide enough to provide meaningful information on the structure of at least one layer in Device Under Test. It can be an incandesced light bulb, a white light Light Emitting Diode (LED), or any other light source meeting the continuous broadband emission requirement known to those skilled in the art. For infrared applications it may comprise a black body source.

The optical assembly (hereafter denoted as OA1) for delivery of light emitted by the light source to the first polarization assembly (hereafter denoted as PA1) may comprise at least one optical lens (component 2 in FIG. 8). The OA1 is used to produce a collimated or quasi-collimated beam of polychromatic light toward the PA1. While it is preferable that the components comprising OA1 are made of either achromatic optical parts or dispersion compensated by design, this requirement is not essential for the functioning of the apparatus of the present embodiment and some applications may be well addressed without meeting the achromatic and/or dispersion compensation requirement.

The first polarization assembly (PA1, components 3 and 4 in FIG. 8) may comprise the polarizing component, such as Glan-Thompson polarizer, wire-grid polarizer or any other polarizing component known to those skilled in the art to select a predetermined linear polarization state of the transmitted light. According to another aspect of the present embodiment the PA1 may comprise a combination of the polarizer (component 4 in FIG. 8) and a wave plate (component 3 in FIG. 8), such as quarter wave plate, half wave plate or any other polarization component known to those skilled in the art. It is preferred to use achromatic or dispersion compensated components, although non achromatic components can be used as well and the dispersion effects can be at least partially compensated by the proper calibration and mathematical post-processing of the data. According to the present embodiment the PA1 is defining the state of polarization of light illuminating the device under test. The polarization state of the transmitted light may be set to be linearly polarized. Alternatively, it may be set to be circularly or elliptically polarized. The polarization state of the transmitted light might be polarized differently at different portions of its spectrum.

The beam-shaping optical assembly (component 5 in FIG. 8) can be optionally added to the apparatus of the present embodiment. It may comprise, for example, a beam expanding means known to those skilled in the art to accommodate the characterization of large area device under test. Other types of beam shaping components or assemblies can be used as well to accommodate the requirements of the particular application

The Device Under Test (component 6 in FIG. 8) according to one aspect of the present embodiment comprises at least one layer of material on the substrate of different material. For a nonlimiting example, it can comprise a semiconductor/dielectric stack (such as the solar cell) on polymer metal substrate. For another nonlimiting example, the device under test may comprise a dielectric stack such as the flat panel display structure. The surface of the film according to the one aspect of the present invention may be optically flat. Alternatively, the surface of the film may be structured or roughened. For a nonlimiting example of solar cell, the surface of the device under test may be structured with random or regular structure (such as an antireflection coating) with certain period (for regular structure) or root mean square parameter characterizing the structure (in the case of random structuring). For such applications it may be advisable to use mid wave infrared optics or long wave infrared optics to minimize the diffraction and blurring effects.

According to this embodiment of the present invention the Device Under Test is illuminated by said polychromatic light at an angle that the polarization state of the reflected light is modified substantially because of the structural properties of the Device Under Test (such as thicknesses and optical constants of the individual thin film layers comprising device under test, surface and interface roughness or structure, stresses in the DUT, etc). For a nonlimiting example the angle of illumination may be Brewster angle or pseudo-Brewster angle. The light reflected by the DUT will thus contain a spectro-polarimetric feature related to the DUT's thin film structure.

According to the second embodiment of the present invention an optical assembly (hereafter denoted as OA2, component 7 in FIG. 8) for delivery of light reflected from the DUT to the second polarization assembly (hereafter denoted as PA2) may comprise at least one optical lens for beam shaping and collimation. It may comprise, for a nonlimiting example, two lenses and a spatial filter (for example, a pinhole) to change the size of the beam, to better collimate it and to filter it spatially. While it is preferable that the components comprising OA1 are made of either achromatic optical parts or dispersion compensated by design, this requirement is not essential for the functioning of the apparatus of the present embodiment and some applications may be well addressed without meeting the achromatic and/or dispersion compensation requirement.

According to the second embodiment of the present invention a second polarization assembly (PA2, components 8, 9 and 10 in FIG. 8) for modulating the spatial content of light reflected from device under test according to the polarization state of said reflected light may comprise at least one Savart plate and a polarizer. According to another aspect of the present embodiment the PA2 may comprise two Savart plates (components 8 and 10 in FIG. 8), half wave plate (component 9 in FIG. 8) and a polarizer (which can be positioned anywhere between components 10 and 14 in FIG. 8). Each Savart plate is made of two uniaxial crystals. In one of the uniaxial crystals, the light reflected from the DUT is split into the ordinary (o) and extraordinary (e) beams and the lateral displacement is introduced only for the extraordinary beam. The Savart plate splits the orthogonally-polarized components of the light reflected from the DUT into the parallel beams which are laterally separated with each other along the 45° direction with respective to its polarization axes. The orthogonal polarization-axes of both Savart plates are aligned to predetermined directions (for a nonlimiting example, ±45° with respect to the polarizer orientation). Each Savart plate thereby introduces the lateral shear. The half wave plate rotates the polarization-coordinate by 45° and the analyzer extracts the linearly-polarized component along the certain polarization axis. With this configuration, the light reflected from the DUT is split into four waves in PA2 thus providing the spatial encoding of the polarization state of the light.

According to this embodiment of the present invention the hyperspectral imaging assembly (components 11, 12, 13 and 14 in FIG. 8) comprises at least one dispersive optical component (component 11 in FIG. 8) and photodetector means (component 14 in FIG. 8). Said dispersive optical component serves to provide a dispersed image on the plane of photodetector means. Said dispersive optical component can be one or two dimensional reflection or transmission type diffraction grating providing nondispersed (zero diffraction order) and at least one dispersed (higher diffraction orders) images of the DUT to the photodetector means. Said photodetector means comprises a set of photodetectors arranged in two dimensions such as CCD camera, CMOS camera or any other camera known to those skilled in the art. Optical imaging assembly (component 12 in FIG. 8) can be optionally used and can comprise one or more lenses, aperture (or field stop) and any other optical elements known to those skilled in the art for image formation, shaping and delivery. According to one aspect of the present invention the hyperspectral imaging optical assembly further contains the gray scale mask (component 13 in FIG. 8) for uniformization of the intensity distribution in the plane of the photodetector means. The purpose of the hyperspectral imaging optical assembly is to provide the necessary data for reconstruction of spatio-specto-polarimetric reflectivity from the DUT.

According to the second embodiment of the present invention the data processing means comprises reconstructing spatio-spectro-polarimetric distribution of the reflectivity from the DUT. The reconstruction of the spatio-spectro-polarimetric distribution of the reflectivity can comprise the steps of computer tomographic hyperspectral reconstruction and polarimetric reconstruction. The computer tomographic hyperspectral reconstruction can be performed by using MART, Expectation Maximization algorithm, heuristic algorithm or any other algorithm known to those skilled in the art. Polarimetric reconstruction can be performed by steps of inverse Fourier transform, filtering the transformed data array and Fourier transform of the filtered data in the spatial domain. Further mathematical processing may be performed as well (such as normalization by the reference spectrum, smoothing, fitting, etc). The reconstructed data will thus provide the means for further processing to identify the structural parameters of the DUT.

In both first and second embodiments of the present invention the calibration of the apparatus of the present invention is a key step, determining the performance of said apparatus. In prior art the CTHI system calibration is typically performed by scanning the fiber in the imaging plane and changing the emitted wavelength by using the monochromator. The full calibration of the system represent a lengthy process (with duration in the range of hours) and hardly practical. The shorter calibration method involves the measurement of the system response at fixed location of the fiber in the image plane and scanning the wavelength. Such a calibration procedure can take few seconds but the accuracy of such a procedure relies on the assumption of shit invariancy of the system, which is in general incorrect (due to aberrations and manufacturing imperfections of the optical components comprising the system). It is an object of the present invention to provide a fast and accurate method of calibration of the thin film characterization apparatus of the present invention. The calibration method of the present invention is based on a special calibration article shown schematically by nonlimiting illustrative FIG. 9. Such a calibration article comprises at least one flat substrate with a number of areas containing distinct spectropolarimetric features. For a nonlimiting example those features may comprise narrowband reflection filters, such as multilayer structures, deposited or fixed in any other method to the surface of the substrate. In another aspect the surface of the flat substrate may contain the low reflectivity coating (such as, for a nonlimiting example, carbon paint) to minimize the reflectivity of the substrate aside the areas with distinct spectropolarimetric features. The interpolation procedure will be used for determination of the missing values of H-matrix. Such an approach provides the opportunity for fast (“single-shot”) calibration procedure compared to up to several hours long calibration procedure with monochromator and spatially scanned fiber.

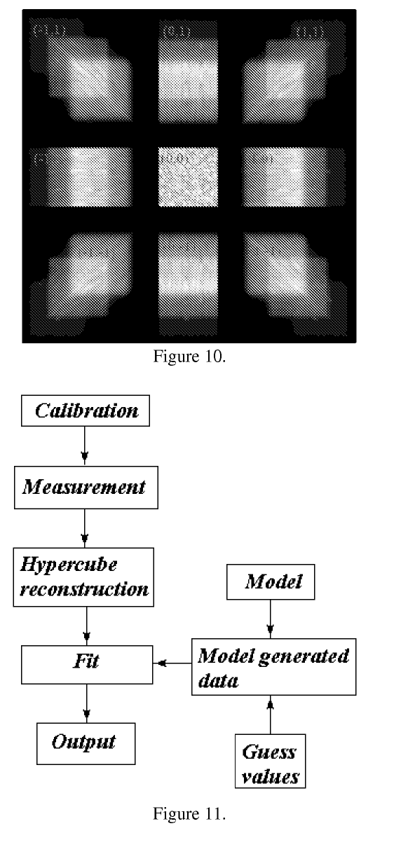

FIG. 10 shows the exemplarly calculated illustrative intensity distribution of the spectropolarimetric thin film characterization apparatus of the present invention with the described above gray scale mask located between the dispercive element and the photodetector means and a typical 2D grating etched into glass with period of 18 micrometers and amplitude of corrugation of 368 nm, illuminated by the visible light. The use of gray scale filter makes the intensities of images of different diffractive orders of roughly the same amplitude, thus expanding the dynamic range of the apparatus compared the the prior art schemes without the use of the gray scale masks.

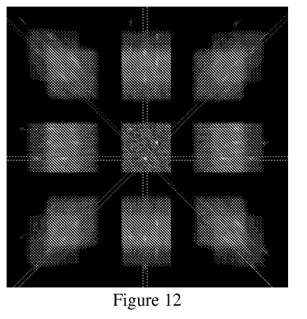

According to the third embodiment, the present invention provides a method of thin film characterization with the spectropolarimetric imaging apparatus of the present invention. The method of this embodiment is illustrated in FIG. 11. It can be applied to both first and second embodiments of the present invention. Said method comprises: (i) calibration of the spectropolarimetric imaging apparatus, (ii) irradiation of the surface of the device under test (comprising at least one thin film) with polychromatic light with predetermined polarization state so that the light is internally or externally reflected at said surface of the device under test, said light possessing a spectropolarimetric features upon reflection from the thin film layer structure of the device under test, (iii) modulating spatially (as with apparatus of the second embodiment of the present invention) or spectrally (as will apparatus of the first embodiment of the present invention) the reflected light according to the polarization state of said reflected light, (iv) dispersing the reflected modulated light by a dispersive element, (v) imaging the dispersed light on a two-dimensional photodetector, (vi) measuring the intensities of dispersed and undispersed light reflected from different parts of the device under test and impinging on different parts of the photodetector, (vii) data processing to retrieve spectropolarimetric reflectivity distribution over the surface of the device under test, (viii) providing an optical model of the thin film layers of the device under test, (ix) providing guess values of the parameters of the thin film layers of the device under test, (x) performing fitting procedure to find the values of the thin film structure of the device under test in at least one spatial point of the image of surface of the device under test.

Such a method will provide the complete spectropolarimetric information about the DUT surface and thus is suitable for the very wide range of applications. The drawback of such a method is the significant computational burden requiring either special signal processor or slowing down the measurement procedure. However, for certain applications, which does not require the complete spectropolarimetric information on the DUT surface but rather require the knowledge of the presence or absence of spatial or spectro-polarimetric “anomalies” in the DUT (such as, for a nonlimiting example, areas of the DUT with nonuniform thickness/composition of thin films), the full reconstruction of the four dimensional data cube may not be required. The nonlimiting illustrative example of such applications may the in-line manufacturing diagnostics of the thin film deposition process (such as in CuInSe2 solar cells). For these applications different method may be preferred.

The basis of the approach that is behind such a method of the present invention is the fact that the spatio-spectro-polarimetric anomaly in the hypercube manifests itself as intensity peculiarities in thin film characterization apparatus' nonreconstruced image as well, as schematically illustrated in calculated FIG. 12. Hence, in principle, the anomalies can be detected from the statistical analysis of the nonreconstructed raw image without the computationally-intense full hypercube restoration. To accomplish it one will need to statistically analyze the nonreconstructed raw images and identify the anomalies in intensity distribution (with mathematical processing and optionally buy mathematically comparing the raw data with preliminary stored reference data); selectively reconstruct the hypercube portions in areas of detected anomalies (highlighted in FIG. 12), and detect anomalies in the reconstructed hypercube portions and identify the nature of anomalies. Implementation of such a method for in-line manufacturing diagnostics is provided in the fourth embodiment of the present invention:

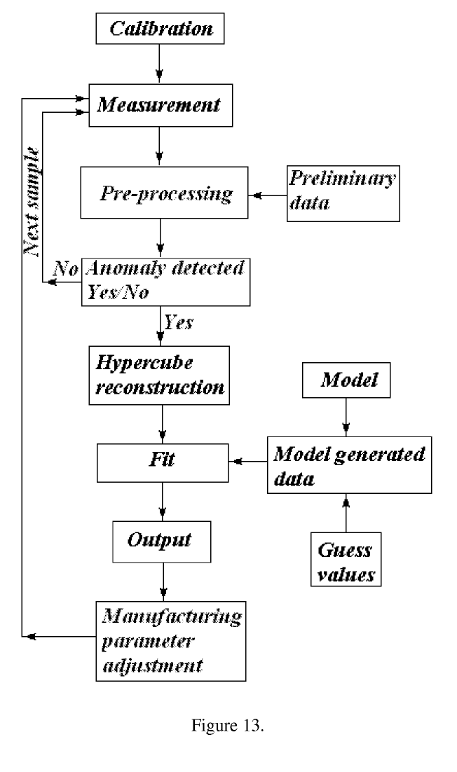

According to the fourth embodiment, illustrated schematically in FIG. 13, the present invention provides a method of diagnostics and control of thin film fabrication processes with the spectropolarimetric imaging apparatus of the present invention. Said method comprises: (i) calibration of the spectropolarimetric imaging apparatus, (ii) generating preliminary data illustrative of the expected and desired specropolarimetric spatial characteristics of the thin film structure, (iii) measurements of the thin film structure with spectropolarimetric imaging apparatus of the present invention, (iv) mathematically comparing said preliminary generated data with measured data and identifying the degree and spatial locations over thin film structure where the difference between the expected data and measured data exceeds the preliminary set fabrication tolerances, (v) partially reconstructing the spatio-spectro-polarimetric hypercube in the said locations where the difference between the expected data and measured data exceeds the preliminary set fabrication tolerances, (vi) mathematically processing the reconstructed data and identifying the guess on fabrication parameters to be adjusted, (vii) adjusting the fabrication parameters to minimize the difference between expected and measured data.

The method and apparatus of the present invention are broadly applicable for characterization, quality control and manufacturing diagnostics of the thin film structures. The present method is particularly useful for in-line manufacturing diagnostics and control of solar cell, flat panel displays and semiconductor devices, where high speed characterization tool is required to meet the manufacturing process throughput. The advantage of the method and apparatus of the present invention is that they provide high-throughput, high accuracy/high resolution technique for thin film characterization.

While the invention has been described in connection with what is presently considered to be the most practical and preferred embodiment, it is to be understood that the invention is not to be limited to the disclosed embodiments. For example, while the design of the dispersive element in the form of the diffraction grating has been disclosed in certain embodiments, other types of dispersive elements can be utilized as well, such as those based on photonic bandgap effect, or refraction effect. Therefore, the metes and bounds of invention are defined by the claims—not by this specification—and are intended to cover various modifications and equivalent arrangements included within the scope of those claims.

What is claimed is:

1. An apparatus for examining material system comprising:
a polychromatic light source emitting a beam of light,
a first polarizing means for selecting the state of polarization of the beam of light,
a material system comprising at least one thin film layer,
an optical means for illuminating said material system with said light beam with selected state of polarization,
an optical means for delivery of light reflected from a material system means to the second polarizing means,
a second polarizing means for modulating the spectral content of the light reflected from the material system means according to the polarization state of said reflected light,
a dispersive means for dispersing of light reflected from the material system means with spectrally modulated content by second polarizing means,
a photodetector means for detecting intensities of said dispersed light,
a signal processing means for mathematically analyzing signal from the photodetector means and providing data related to the spatio-spectro-polarimetric characteristics of said material system.

2. The apparatus of claim 1, wherein said light source emits a continuous light spectrum over at least some spectral band.

3. The apparatus of claim 2 wherein said light source is selected from the group consisting of a lamp, light emitting diode, superluminescent light emitting diode and black body radiation source.

4. The apparatus of claim 1 wherein said photodetector means comprises a two-dimensional photodetector matrix.

5. The apparatus of claim 1 wherein a gray-scale mask is provided in the optical path between the dispersive means and photodetector means, wherein said gray scale mask provides spatially nonuniform transmission.

6. The apparatus of claim 1 wherein said dispersive means comprises a diffraction grating.

7. The apparatus of claim 1 wherein said dispersive means comprises a holographic grating.

8. The apparatus of claim 1 wherein said first polarizing means comprises a single polarizer for selecting the linear polarization of the transmitted light.

9. The apparatus of claim 1 wherein said first polarizing means comprises a combination of at least one polarizer and at least one wave plate.

10. The apparatus of claim 1 wherein said material system comprises at least one thin film layer on a substrate with flat interfaces.

11. The apparatus of claim 1 wherein said material system comprises at least one thin film layer on a substrate with at least one structured interface.

12. The apparatus of claim 1 wherein said second polarizing means comprises at least two retarder components and at least one polarizing component.

13. The apparatus of claim 1 wherein said mathematical analysis of the signal comprises the reconstruction of the spatio-spectro-polarimetric data cube of the image of said material system.

14. The apparatus of claim 1 wherein the imaging optics is provided on the optical path between the dispersive means and photodetector means.

15. The apparatus of claim 1 wherein at least one spectral filtering means is positioned in the optical path between the light source and photodetector for filtering out the unwanted part of light source's emission spectrum.

16. The apparatus of claim 1 wherein said spato-spectro-polarimetric characteristics of the material system are defined by the properties of said at least one thin film comprising the material system selected from the group consisted of physical thickness of said at least one thin film, refractive index of said at least one thin film, absorption coefficient of said at least one thin film, interface roughness of said at least one thin film and stress distribution in said at least one thin film.

17. The apparatus of claim 1 wherein said material system is the solar cell.

18. An apparatus for examining material system comprising:
a polychromatic light source emitting a beam of light,
a first polarizing means for selecting the state of polarization of the beam of light,
a material system comprising at least one thin film layer,
an optical means for illuminating said material system with said light beam with selected state of polarization,
an optical means for delivery of light reflected from a material system means to the second polarizing means,
a second polarizing means for modulating the spatial content of the light reflected from the material system means according to the polarization state of said reflected light,
a dispersive means for dispersing of light reflected from the material system means with spectrally modulated content by second polarizing means,
a photodetector means for detecting intensities of said dispersed light,
a signal processing means for mathematically analyzing signal from the photodetector means and providing data related to the spatio-spectro-polarimetric characteristics of said material system.

19. The apparatus of claim 18, wherein said light source emits a continuous light spectrum over at least some spectral band.

20. The apparatus of claim 19 wherein said light source is selected from the group consisting of a lamp, light emitting diode, superluminescent light emitting diode and black body radiation source.

21. The apparatus of claim 18 wherein said photodetector means comprises a two-dimensional photodetector matrix.

22. The apparatus of claim 18 wherein a gray-scale mask is provided in the optical path between the dispersive means and photodetector means, wherein said gray scale mask provides spatially nonuniform transmission.

23. The apparatus of claim 18 wherein said dispersive means comprises a diffraction grating.

24. The apparatus of claim 18 wherein said dispersive means comprises a holographic grating.

25. The apparatus of claim 18 wherein said first polarizing means comprises a single polarizer for selecting the linear polarization of the transmitted light.

26. The apparatus of claim 18 wherein said first polarizing means comprises a combination of at least one polarizer and at least one wave plate.

27. The apparatus of claim 18 wherein said material system comprises at least one thin film layer on a substrate with flat interfaces.

28. The apparatus of claim 18 wherein said material system comprises at least one thin film layer on a substrate with at least one structured interface.

29. The apparatus of claim 18 wherein said second polarizing means comprises at least one Savart plate and at least one polarizing component.

30. The apparatus of claim 18 wherein said second polarizing means comprises two Savart plates, half wave plate and at least one polarizing component.

31. The apparatus of claim 18 wherein said mathematical analysis of the signal comprises the reconstruction of the spatio-spectro-polarimetric data cube of the image of said material system.

32. The apparatus of claim 18 wherein the imaging optics is provided on the optical path between the dispersive means and photodetector means.

33. The apparatus of claim 18 wherein at least one spectral filtering means is positioned in the optical path between the light source and photodetector for filtering out the unwanted part of light source's emission spectrum.

34. The apparatus of claim 18 wherein said spato-spectro-polarimetric characteristics of the material system are defined by the properties of said at least one thin film comprising the material system selected from the group consisted of physical thickness of said at least one thin film, refractive index of said at least one thin film, absorption coefficient of said at least one thin film, interface roughness of said at least one thin film and stress distribution in said at least one thin film.

35. The apparatus of claim 18 wherein said material system is the solar cell.

36. A method of characterizing the material system with spectropolarimetric imaging apparatus, which method comprises:
calibration of the spectropolarimetric imaging apparatus,
irradiation of the surface of the material system comprising at least one thin film with polychromatic light with predetermined polarization state so that the light is internally or externally reflected at said surface of the material system, said light possessing a spectropolarimetric features upon reflection from the thin film layer structure of the material system,
modulating spatio-spectral characteristics the reflected light according to the polarization state of said reflected light,
dispersing the reflected modulated light by a dispersive element,
imaging the dispersed light on a two-dimensional photodetector,
measuring the intensities of dispersed and not dispersed light reflected from different parts of the surface of the material system and impinging on different parts of the photodetector,
data processing to retrieve spectropolarimetric reflectivity distribution over the surface of the material system,
providing an optical model of the thin film layers of the material system,
providing guess values of the parameters of the thin film layers of the material system,
performing fitting procedure to find the values of the thin film structure of the material system in at least one spatial point of the image of surface of the material system.

37. The method according to claim 36 wherein calibration measurements are performed preliminary and said calibration measurements are utilized in determining the reflection at the different incident light wavelengths for at least one spatial location on a surface.

38. The method according to claim 36 wherein said guess values are determined preliminary to characterization of material structure.

39. The method according to claim 36 wherein said guess values are determined based on mathematical analysis of the measurement results.

40. A method of diagnostics and control of thin film fabrication processes having at least one fabrication parameter with spectropolarimetric imaging apparatus, which method comprises:
calibration of the spectropolarimetric imaging apparatus,
generating preliminary data illustrative of the expected and desired specropolarimetric spatial characteristics of the thin film structure,
measurements of the thin film structure with spectropolarimetric imaging apparatus,
mathematically comparing said preliminary generated data with measured data and identifying the degree and spatial locations over thin film structure where the difference between the expected data and measured data exceeds the preliminary set fabrication tolerances,
partially reconstructing the spatio-spectro-polarimetric data volume in the said locations where the difference between the expected data and measured data exceeds the preliminary set fabrication tolerances,
mathematically processing the reconstructed data and identifying the guess on fabrication parameters to be adjusted,
adjusting the fabrication parameters to minimize the difference between expected and measured data.

41. The method according to claim 40 wherein said fabrication process is selected from the group consisted of chemical vapor deposition, molecular beam epitaxy, atomic layer deposition, magnetron sputtering, thermal evaporation, ion beam deposition, electron beam deposition, flame hydrolysis, reactive ion etching and chemical etching.

42. The method according to claim 40 wherein said fabrication process is selected from the group consisted of power, voltage, current, gas pressure, gas flow, duraction, distance, orientation and concentration.
